(19) United States
(12) Patent Application Publication
(10) Pub. No.: US 2016/0021352 A1
(43) Pub. Date: Jan. 21, 2016

(54) COLOR SHADING CORRECTION USING COLOR CHANNEL CONSISTENCY

(71) Applicant: Samsung Electronics Co., Ltd., Suwon-Si (KR)

(72) Inventor: Dmitriy RUDOY, Ramat Gan (IL)

(21) Appl. No.: 14/336,295

(22) Filed: Jul. 21, 2014

(51) Int. Cl. H04N 9/73; G06T 11/00; G06T 7/40

(52) U.S. Cl. CPC H04N 9/735; G06T 7/408; G06T 11/001

(57) ABSTRACT

An imaging system includes a color correction circuit configured to perform in color shading correction of an image independent of lens shading correction of the image. A method for anti-shading correction of an image includes correcting, by a color correction circuit, for color shading of the image independent of lens shading correction of the image.

### BACKGROUND

Lens shading (also known as vignetting) is an optical effect that occurs when less light penetrates through the periphery of a lens than through the center. Lens shading causes corners of an image to become darker than the center of the image.

Color shading occurs when the shading of different color channels is different. Color shading results in unbalanced colors towards the periphery of the image. This effect may be found in most imaging systems, but becomes more substantial as image sensor size (or pixel size) decreases.

Effects of color shading usually accompany lens shading. Thus, conventional anti-shading correction methods only target lens shading correction directly. As a result, conventional anti-shading correction methods correct color shading and lens shading together, rather than separate and independently.

### SUMMARY

One or more example embodiments provide an anti-shading correction mechanism that allows for correction of color shading separate and/or independently of lens shading correction. At least some example embodiments utilize consistency between color channels to adapt an anti-shading correction function, which is then utilized to correct for color shading in an obtained image.

At least one example embodiment provides an imaging system including a color correction circuit configured to perform color shading correction of an image independent of lens shading correction of the image.

The color correction circuit may include: a color consistency correction circuit configured to generate color shading correction grids by adapting anti-shading correction grids for red and blue color channels of the image based on estimated color consistency models for the red and blue color channels of the image; and an anti-shading correction circuit configured to perform the color shading correction of the image based on the color shading correction grids.

The color consistency correction circuit may be configured to generate the color shading correction grids by adapting anti-shading correction grids for only the red and blue color channels. The estimated color consistency model for the red color channel may include a common profile for the red color channel and an estimated gamma coefficient for the red color channel, and the estimated color consistency model for the blue color channel may include a common profile for the blue color channel and an estimated gamma coefficient for the blue color channel. The estimated gamma coefficients for the red and blue color channels may correspond to an estimated color temperature for the image.

The color consistency correction circuit may be configured to generate the estimated gamma coefficient for the red color channel based on a plurality of reference gamma coefficients for the red color channel using interpolation. The plurality of reference gamma coefficients for the red color channel may correspond to a plurality of reference color temperatures.

The color consistency correction circuit may be configured to generate the estimated gamma coefficient for the blue color channel based on a plurality of reference gamma coefficients for the blue color channel using interpolation. The plurality of reference gamma coefficients for the blue color channel may also correspond to a plurality of reference color temperatures.

The anti-shading correction circuit may be further configured to: generate color shading correction functions for each of the red and blue color channels based on the color shading correction grids; and perform the color shading correction of the image by applying the color shading correction functions to each pixel of the image.

The anti-shading correction circuit may be further configured to perform the lens shading correction of the image.

The color consistency correction circuit may be further configured to generate the estimated color consistency models for the red and blue color channels of the image based on an estimated color temperature for the image.

The color consistency correction circuit may be further configured to: obtain reference color consistency models for the red and blue color channels based on the estimated color temperature for the image; and generate the estimated color consistency models for the red and blue color channels based on the obtained reference color consistency models for the red and blue color channels.

The color correction circuit may further include: a color inconsistency information extraction circuit configured to extract color inconsistency information from a plurality of reference images, each of the plurality of reference images being captured under light having a different color temperature among a plurality of reference color temperatures; and a color consistency model estimation circuit configured to generate a reference color consistency model for each of the plurality of reference images, the color consistency model estimation circuit being further configured to store the reference color consistency models in a memory. The color consistency correction circuit may be further configured to generate the estimated color consistency models for the red and blue color channels based on at least a portion of the reference color consistency models and the estimated color temperature for the image.

Extracted color inconsistency information for a reference image among the plurality of reference images may include a ratio of green-to-red color channels for each pixel of the reference image and a ratio of green-to-blue color channels for each pixel of the reference image.

A reference color consistency model for a reference image among the plurality of reference images may include a common profile and a reference gamma coefficient corresponding to a color temperature for the reference image. The color consistency model estimation circuit may be configured to: calculate the common profile based on an initial reference gamma coefficient; calculate an updated reference gamma coefficient based on the calculated common profile; calculate an updated common profile based on the updated reference gamma coefficient; and iteratively repeat the calculation of the updated reference gamma coefficient and the updated common profile until convergence to generate the reference color consistency model for the reference image.

The imaging system may further include: an image sensor operatively coupled to the color correction circuit, the image sensor being configured to capture the image.

At least one other example embodiment provides a method for anti-shading correction of an image, the method including: correcting, by a color correction circuit, for color shading in the image independent of lens shading correction of the image.

The method may further include: generating color shading correction grids by adapting anti-shading correction grids for red and blue color channels of the image based on estimated color consistency models for the red and blue color channels of the image; and wherein the correcting corrects for the color shading of the image based on the color shading correction grids.

The generating the color shading correction grids may include adapting anti-shading correction grids for only the red and blue color channels to generate the color shading correction grids.

The estimated gamma coefficient for the red color channel may be generated based on a plurality of reference gamma coefficients for the red color channel using interpolation. The plurality of reference gamma coefficients for the red color channel may correspond to a plurality of reference color temperatures.

The estimated gamma coefficient for the blue color channel may be generated based on a plurality of reference gamma coefficients for the blue color channel using interpolation. The plurality of reference gamma coefficients for the blue color channel may correspond to a plurality of reference color temperatures.

The estimated color consistency models for the red and blue color channels of the image may be generated based on an estimated color temperature for the image.

The generating the estimated color consistency models may include: obtaining reference color consistency models for the red and blue color channels from a memory based on the estimated color temperature for the image; and calculating the estimated color consistency models for the red and blue color channels based on the obtained reference color consistency models for the red and blue color channels.

Color inconsistency information may be extracted from a plurality of reference images, each of the plurality of reference images being captured under light having a different color temperature among a plurality of reference color temperatures; a reference color consistency model may be generated for each of the plurality of reference images; and the reference color consistency models may be stored in the memory.

A reference color consistency model for a reference image among the plurality of reference images may include a common profile and a reference gamma coefficient corresponding to the color temperature for the reference image. The generating the reference color consistency models may include: calculating the common profile based on an initial reference gamma coefficient; calculating an updated reference gamma coefficient based on the calculated common profile; calculating an updated common profile based on the updated reference gamma coefficient; and iteratively repeating the calculation of the updated reference gamma coefficient and the updated common profile until convergence to generate the reference color consistency model for the reference image.

### BRIEF DESCRIPTION OF THE DRAWINGS

Example embodiments will become more appreciable through the description of the drawings in which:

FIG. 1 is a block diagram illustrating an imaging system according to an example embodiment.

FIG. 2 is a more detailed block diagram of an example embodiment of the image sensor 1000 shown in FIG. 1.

FIG. 3 is a flow chart illustrating an example embodiment of a method for calibrating a color correction circuit.

FIG. 4 is a flow chart illustrating an example embodiment of a method for color correction of an image.

FIG. 5 is a block diagram illustrating an electronic system according to an example embodiment.

### DETAILED DESCRIPTION

Example embodiments will now be described more fully with reference to the accompanying drawings. Many alternate forms may be embodied and example embodiments should not be construed as limited to example embodiments set forth herein. In the drawings, like reference numerals refer to like elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware in existing electronic systems (e.g., electronic imaging systems, image processing systems, digital point-and-shoot cameras, personal digital assistants (PDAs), smartphones, tablet personal computers (PCs), laptop computers, etc.). Such existing hardware may include one or more Central Processing Units (CPUs), digital signal processors (DSPs), application-specific-integrated-circuits (ASICs), field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or non-transitory computer readable storage medium” may represent one or more devices for storing data, including read only memory (ROM), random access memory (RAM), magnetic RAM, core memory, magnetic disk storage mediums, optical storage mediums, flash memory devices and/ or other tangible or non-transitory machine readable mediums for storing information. The term “computer-readable medium” may include, but is not limited to, portable or fixed storage devices, optical storage devices, and various other tangible or non-transitory mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors may be programmed to perform the necessary tasks, thereby being transformed into special purpose processor(s) or computer(s).

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Example embodiments provide methods and apparatuses for color and/or anti-shading correction of images. Example embodiments also provide electronic systems including apparatuses for color and/or anti-shading correction, and methods of generating color and/or anti-shading corrected images. According to at least some example embodiments, effects of color shading are corrected separately from effects of lens shading.

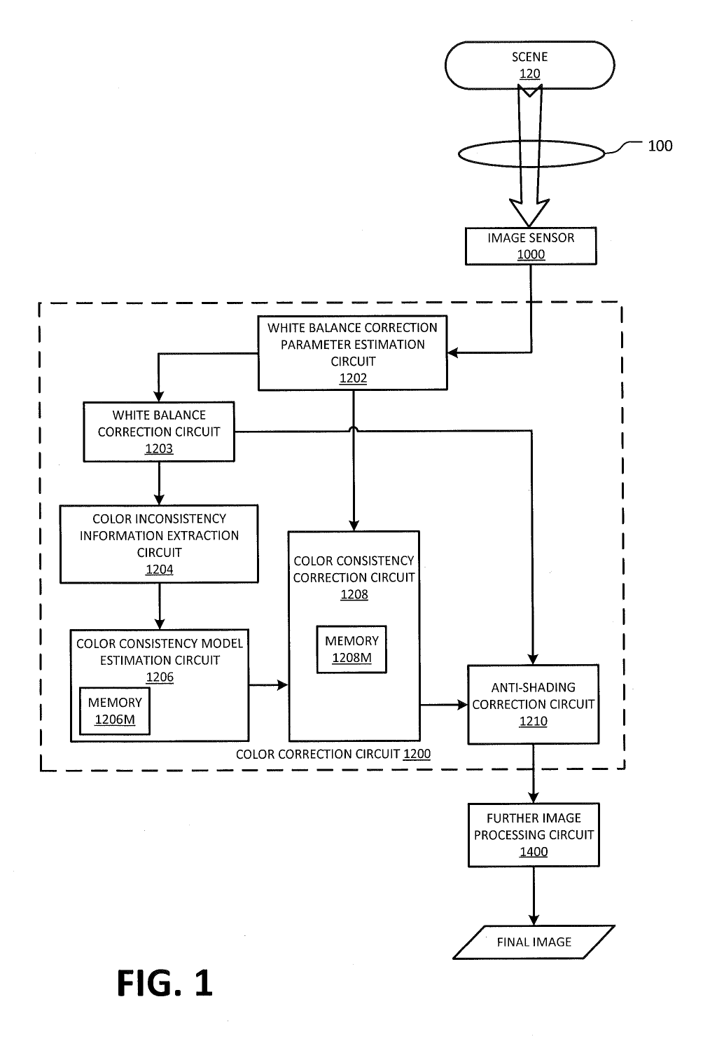

FIG. 1 illustrates an imaging system according to an example embodiment.

Referring to FIG. 1, the imaging system includes a lens unit 100 coupled to an image sensor 1000. The image sensor 1000 is coupled to a color correction circuit 1200. The color correction circuit 1200 is operatively coupled to a further image processing circuit 1400.

The lens unit 100 includes focusing optics (e.g., one or more lenses and/or mirrors) to focus and form an image of a scene 120 on the image sensor 1000 using subject light passing through the lens unit 100. Because lens units and focusing optics are generally well-known a detailed discussion is omitted.

In example operation, the image sensor 1000 captures one or more images of the scene 120 (e.g., including one or more objects and a background), and outputs the captured one or more images (e.g., serially or sequentially) to the color correction circuit 1200.

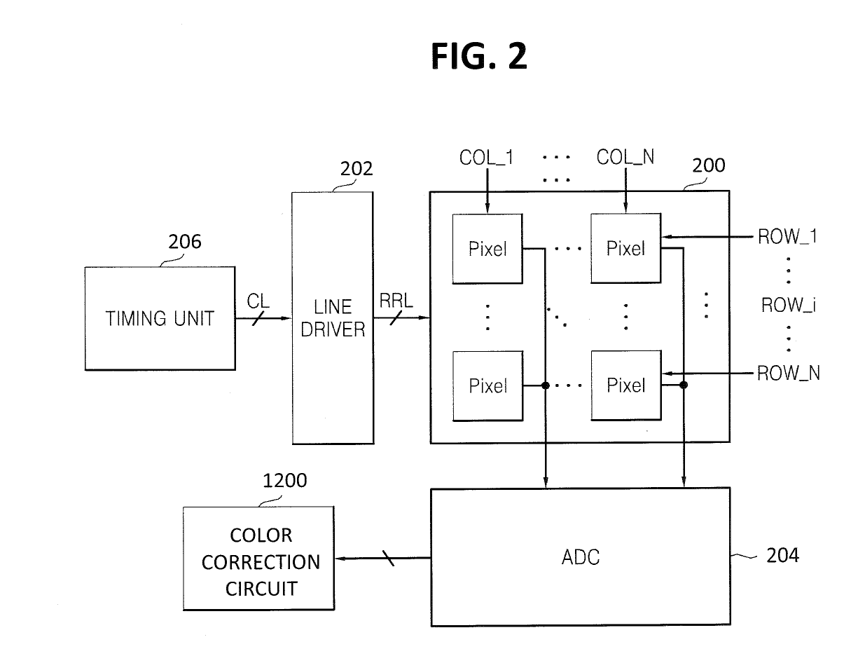

FIG. 2 is a more detailed block diagram of an example embodiment of the image sensor 1000 shown in FIG. 1. In the example shown in FIG. 2, the images sensor 1000 is a complementary-metal-oxide-semiconductor (CMOS) image sensor. However, example embodiments should not be limited to this example.

Referring to FIG. 2, a timing unit or circuit 206 controls a line driver 202 through one or more control lines CL. In one example, the timing unit 206 causes the line driver 202 to generate a plurality of transfer pulses (e.g., readout and/or shutter). The line driver 202 outputs the transfer pulses to a pixel array 200 over a plurality of read and reset lines RRL.

The pixel array 200 includes a plurality of pixels arranged in an array of rows ROW_1-ROW_N and columns COL_1-COL_N. As discussed herein, rows and columns may be collectively referred to as lines. Each of the plurality of read and reset lines RRL corresponds to a line of pixels in the pixel array 200 having a Bayer color pattern. In FIG. 2, each pixel may be an active-pixel sensor (APS), and the pixel array 200 may be an APS array.

In the Bayer color pattern, ‘R’ represents a pixel for sensing read color light, and ‘B’ represents a pixel for sensing blue color light. ‘Gb’ represents a pixel for sensing green color light in a row having alternating green and blue pixels, and ‘Gr’ represents a pixel for sensing green color light in a row having alternating green and red pixels.

As is known, image data generated using a pixel array having a Bayer color pattern is interpolated to generate a R (red) color component channel, a B (blue) color component channel, a Gr (green-red) color component channel, and a Gb (green-blue) color component channel.

The R color component channel indicates a respective intensity of red light reaching each of the pixel locations of the pixel array 200. The B color component channel indicates a respective intensity of blue light reaching each of the pixel locations of the pixel array 200. The Gr color component channel indicates a respective intensity of green light reaching each of the green pixels adjacent red pixels in a row. The Gb color component channel indicates a respective intensity of green light reaching the green pixels adjacent to blue pixels in a row. As discussed herein, a color component channel may also be referred to as a “color channel”.

Returning to FIG. 2, the analog-to-digital converter (ADC) 204 converts the output voltages from the i-th line ROW_i of readout pixels into a digital signal (also referred to herein as image data or an image). The ADC 204 then outputs the image data (or image) to the color correction circuit 1200 in FIG. 1.

Returning to FIG. 1, after being calibrated in a calibration phase, the color correction circuit 1200 performs color and/or anti-shading correction on the image data from the image sensor 1000 in the correction phase. In so doing, the color correction circuit 1200 corrects for effects of color shading in an image separately and independently from correcting for effects of lens shading in the image.

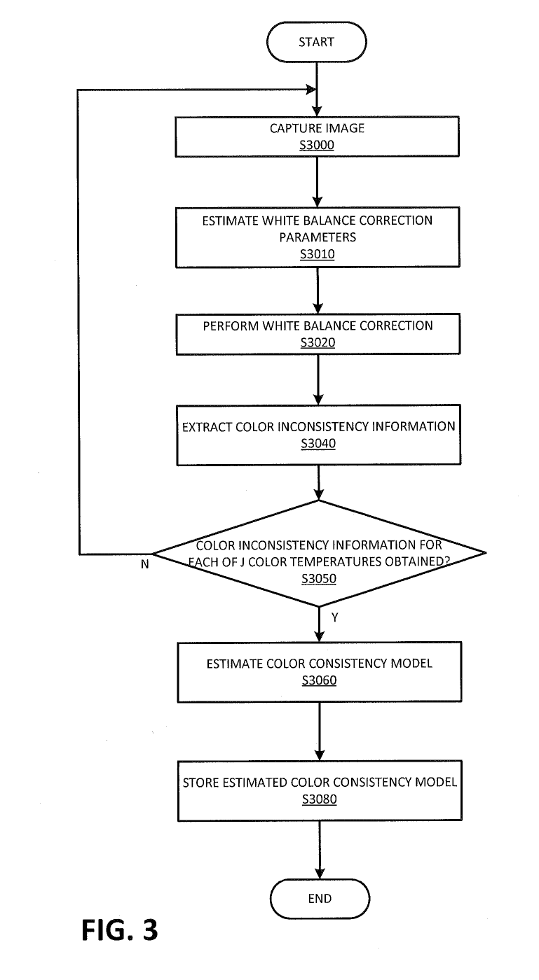

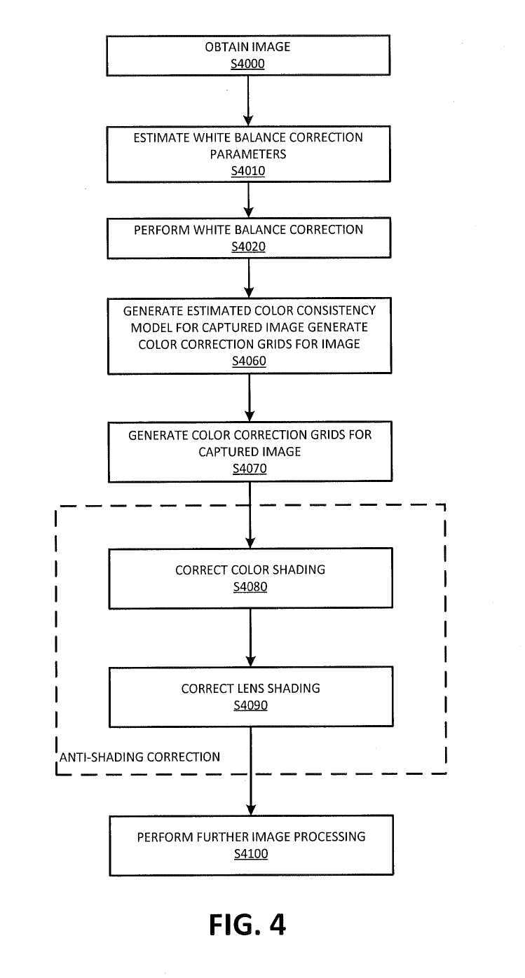

Example operation of the imaging system including the color correction circuit 1200 during an example calibration phase will be discussed in more detail with regard to the flow chart in FIG. 3. Example operation of the imaging system including the color correction circuit 1200 during an example correction phase will be discussed in more detail with regard to the flow chart in FIG. 4.

The color correction circuit 1200 and/or any components thereof may be hardware, firmware, hardware executing software or any combination thereof. When the color correction circuit 1200 is hardware, such hardware may include one or more Central Processing Units (CPUs), system-on-chips (SOCs), digital signal processors (DSPs), application-specific-integrated-circuits (ASICs), field programmable gate arrays (FPGAs) computers or the like configured as special purpose machines to perform the functions of the color correction circuit 1200. CPUs, SOCs, DSPs, ASICs and FPGAs may generally be referred to as processors and/or microprocessors.

Still referring to FIG. 1, the color correction circuit 1200 includes a white balance correction parameter estimation circuit 1202 operatively coupled to a white balance correction circuit 1203 and a color consistency correction circuit 1208.

The white balance correction circuit 1203 is operatively coupled to a color inconsistency information extraction circuit 1204 and an anti-shading correction circuit 1210. The color inconsistency information extraction circuit 1204 is operatively coupled to a color consistency model estimation circuit 1206.

The color consistency model estimation circuit 1206 includes a memory 1206M, and is operatively coupled to the color consistency correction circuit 1208. The memory 1206M may be any suitable volatile or non-volatile memory

The color consistency correction circuit 1208 includes a memory 1208M, and is operatively coupled to the anti-shading correction circuit 1210. The memory 1208M may be any suitable volatile or non-volatile memory.

In FIG. 1, one or more of the white balance correction parameter estimation circuit 1202, the white balance correction circuit 1203, the color inconsistency information extraction circuit 1204, the color consistency model estimation circuit 1206, the color consistency correction circuit 1208, the anti-shading correction circuit 1210, and the further image processing circuit 1400 may be hardware, firmware, hardware executing software or any combination thereof. When implemented as hardware, such hardware may include one or more Central Processing Units (CPUs), system-on-chips (SOCs), digital signal processors (DSPs), application-specific-integrated-circuits (ASICs), field programmable gate arrays (FPGAs) computers or the like configured as special purpose machines to perform the functions of the white balance correction parameter estimation circuit 1202, the white balance correction circuit 1203, the color inconsistency information extraction circuit 1204, the color consistency model estimation circuit 1206, the color consistency correction circuit 1208, the anti-shading correction circuit 1210, and/or the further image processing circuit 1400. CPUs, SOCs, DSPs, ASICs and FPGAs may generally be referred to as processors and/or microprocessors.

FIG. 3 is a flow chart illustrating an example embodiment of a method for calibrating a color correction circuit, such as the color correction circuit 1200 shown in FIG. 1 during a calibration phase.

Referring to FIGS. 1 and 3, at S3000 the image sensor 1000 captures an image Calib_Imageⱼ of the scene 120 under controlled and known light having a known color temperature. In this case, the scene 120 is a white (or, more generally, grey) image of uniformity. The image sensor 1000 captures the image Calib_Imageⱼ of the scene 120 under a known color temperature j, where j is an index identifying a color temperature in a set of J color temperatures. As discussed herein, a color temperature may also be referred to as (or identified by) a corresponding illumination type. In one example, the set of J color temperatures may include: ˜2700K (tungsten); ˜4000K (florescent); ˜5500K (direct sunlight); and ˜6500K (shade). However, example embodiments should not be limited to these example color temperatures. Rather, any number of color temperatures may be used. The J color temperatures may be referred to as reference color temperatures. The image sensor 1000 outputs the captured image to the white balance correction parameter estimation circuit 1202.

At S3010, the white balance correction parameter estimation circuit 1202 estimates white balance correction parameters for performing white balance correction on the image Calib_Imageⱼ. In one example, the white balance correction parameters include: per-color channel gains for correcting white balance of the image Calib_Imageⱼ; and a color temperature for the image Calib_Imageⱼ. During the calibration phase, however, the image Calib_Imageⱼ is captured under light having a known color temperature, and thus, the color temperature need not be estimated at S3010.

Example embodiments may utilize any suitable well-known methods for estimating white balance correction parameters, including per-color channel gains, for correcting white balance in an image. Because methods for estimating white balance correction parameters including per-color channel gains are well-known a detailed discussion is omitted. The white balance correction parameter estimation circuit 1202 outputs the estimated white balance correction parameters and the image Calib_Imageⱼ to the white balance correction circuit 1203.

At S3020, the white balance correction circuit 1203 performs white balance correction on the image Calib_Imageⱼ. As is known, white balance in an image depends on the color temperature and pixel sensitivity of the image sensor 1000, and white balance correction is a process applied to an image to make greys look grey. In more detail, at S3020 the white balance correction circuit 1203 corrects the white balance in the image by multiplying each color channel by the corresponding color channel gain from the white balance correction parameter estimation circuit 1202 to generate a white balanced image WB_Calib_Imageⱼ.

Example embodiments may utilize any suitable well-known white balance correction method. Because methods for correcting white balance in images are well-known, a detailed discussion is omitted.

The white balance correction circuit 1203 outputs the white balanced image WB_Calib_Imageⱼ to the color inconsistency information extraction circuit 1204.

At S3040, the color inconsistency information extraction circuit 1204 extracts and/or generates color inconsistency information for each pixel in the white balanced image WB_Calib_Imageⱼ.

According to at least some example embodiments, the extracted color inconsistency information includes ratios of green-to-red and green-to-blue color channels for each pixel of the white balanced image WB_Calib_Imageⱼ. In this example, the color inconsistency information extraction circuit 1204 calculates a ratio RGⱼ(x,y) of green-to-red color channels for each pixel of the white balanced image WB_Calib_Imageⱼ according to Equation (1) shown below.

$${RG}_{j} ( x , y ) = \frac{{Gr}_{( x , y )}}{{R}_{( x , y )}} \qquad ( 1 )$$

Similarly, the color inconsistency information extraction circuit 1204 calculates the ratio BGⱼ(x,y) of green-to-blue color channels for each pixel of the white balanced image WB_Calib_Imageⱼ according to Equation (2) shown below.

$${BG}_{j} ( x , y ) = \frac{{Gb}_{( x , y )}}{{B}_{( x , y )}} \qquad ( 2 )$$

In Equations (1) and (2), (x,y) is the coordinate of the pixel of the white balanced image WB_Calib_Imageⱼ, B represents the blue color channel, R represents the red color channel, Gr represents the green-red color channel, and Gb represents the green-blue color channel. As discussed above, the index j represents a color temperature of light under which the original image Calib_Imageⱼ was captured.

The color inconsistency information extraction circuit 1204 outputs the color inconsistency information to the color consistency model estimation circuit 1206. The color consistency model estimation circuit 1206 stores the received color inconsistency information in the memory 1206M.

At S3050, the color correction circuit 1200 determines whether color inconsistency information for images obtained under light having each of J color temperatures has been generated. In one example, the color correction circuit 1200 determines whether J sets of color inconsistency information have been generated and stored at the memory 1206M.

If J sets of color inconsistency information have not been generated and stored in the memory 1206M, then the process returns to S3000 and each of S3000, S3010, S3020 and S3040 is repeated for the scene 120 under light having another color temperature from among the set of J color temperatures.

According to at least some example embodiments, S3000, S3010, S3020 and S3040 are performed separately for each of the J color temperatures. As a result, the color correction circuit 1200 extracts color inconsistency information for each of at least J images, and stores at least J sets of color inconsistency information in the memory 1206M at the color consistency model estimation circuit 1206. The J images may also be referred to as reference images.

Returning to S3050 in FIG. 3, if J sets of color inconsistency information have been generated and stored at the memory 1206M, then the process continues to S3060.

At S3060, the color consistency model estimation circuit 1206 estimates color consistency models for each of the J color temperatures based on the J sets of color inconsistency information stored in the memory 1206M.

As discussed herein, a color consistency model for the j-th color temperature is constituted by common profiles (e.g., for red and blue color channels) in combination with gamma coefficients (or “gammas”) for the j-th color temperature.

A common profile is a color temperature independent part of a consistency profile for an image. The common profile provides spatial dependency of the color consistency for a given combination of image sensor and optics.

Normally, the common profile is associated with a set of gamma coefficients (or “gammas”), which model the color temperature dependencies of the color consistency in an image. The gammas serve as a scaling factor for converting a common profile to a color temperature-specific profile. In the other words, the gammas adapt a common profile to a given color temperature. The color temperature-specific profile is also referred to as an illumination-specific profile.

In more detail, the gamma coefficients are multiplication factors that create a color temperature-specific (or illumination-specific) profile from the common profile for a given color temperature (or illumination type). There is a separate set of gamma coefficients for the red and blue color channels. In this regard, the set of gammas for the red color channel includes a red color channel gamma coefficient for each of the J color temperatures, and the set of gammas for the blue color channel includes a blue color channel gamma coefficient for each of the J color temperatures. The number of gammas in the set of gamma coefficients for each color channel is equal to the number of the calibration points for the different color temperatures.

Still referring to S3060, according to at least one example embodiment, the color consistency model estimation circuit 1206 calculates the common profiles for the red and blue color channels along with the gamma coefficients using an iterative least squares procedure. An example calculation for each of the red and blue color channels will be described in more detail below.

In an initial iteration, the color consistency model estimation circuit 1206 estimates the common profile Comm_Prof_{RG}(x,y) for the red color channel according to Equation (3) shown below.

$${Comm\_Prof}_{RG} ( x , y ) = \frac{{Σ}_{j} {RG}_{j} ( x , y ) {γ}_{j , RG}}{{Σ}_{j} {γ}_{j , RG}^{2}} \qquad ( 3 )$$

In this initial iteration, the gamma coefficient γ_{j,RG} for the red color channel is assumed to be 1 for each of the J color temperatures.

The color consistency model estimation circuit 1206 then estimates new/updated gamma coefficients γ_{j,RG} for the red color channel based on the common profile Comm_Prof_{RG}(x,y) for the red color channel according to Equation (4) shown below.

$${γ}_{j , RG} = \frac{{Σ}_{( x , y )} {RG}_{j} ( x , y ) \cdot {Comm\_Prof}_{RG} ( x , y )}{{Σ}_{( x , y )} {Comm\_Prof}_{RG} {( x , y )}^{2}} \qquad ( 4 )$$

The new/updated gamma coefficients γ_{j,RG} for the red color channel are then substituted back into Equation (3), and the iterative calculation is repeated. The color consistency model estimation circuit 1206 repeats the above-discussed iterative calculations until convergence (e.g., approximately two or three iterations) to estimate the common profile Comm_Prof_{RG} (x, y) and associated gammas γ_{j,RG} for the red color channel. This iterative calculation at S3060 provides gammas for the red color channel for each of the J color temperatures, and need only be performed only once. As a result, the color consistency model estimation circuit 1206 obtains a color consistency model for the red color channel including: (i) the common profile; and (ii) the set of gammas for the red color channel. As mentioned above, the generated set of gammas for the red color channel adapt the common profile for the red color channel to a given color temperature.

With regard to the common profile for the blue color channel, in an initial iteration, the color consistency model estimation circuit 1206 estimates the common profile Comm_Prof_{BG}(x,y) for the blue color channel according to Equation (5) shown below.

$${Comm\_Prof}_{BG} ( x , y ) = \frac{{Σ}_{j} {BG}_{j} ( x , y ) {γ}_{j , BG}}{{Σ}_{j} {γ}_{j , BG}^{2}} \qquad ( 5 )$$

In this initial iteration, the gamma coefficient γ_{j,BG} for the blue color channel is again assumed to initially be 1 for each of the J color temperatures.

The color consistency model estimation circuit 1206 then estimates new/updated gamma coefficients γ_{j,BG} for the blue color channel based on the common profile Comm_Prof_{BG}(x,y) for the blue color channel according to Equation (6) shown below.

$${γ}_{j , BG} = \frac{{Σ}_{( x , y )} {BG}_{j} ( x , y ) \cdot {Comm\_Prof}_{BG} ( x , y )}{{Σ}_{( x , y )} {Comm\_Prof}_{BG} {( x , y )}^{2}} \qquad ( 6 )$$

The new/updated gamma coefficients γ_{j,BG} for the blue color channel are then substituted back into Equation (5), and the iterative calculation is repeated. The color consistency model estimation circuit 1206 repeats the above-discussed iterative calculations until convergence (e.g., approximately two or three iterations) to estimate the common profile Comm_Prof_{BG}(x, y) and associated set of gammas γ_{j,BG} for the blue color channel. This iterative calculation at S3060 provides gammas for the blue color channel for each of the J color temperatures, and need only be performed only once. As a result, the color consistency model estimation circuit 1206 obtains a color consistency model for the blue color channel including: (i) the common profile; and (ii) the set of gammas for the blue color channel. As mentioned above, the generated set of gammas for the blue color channel adapt the common profile for the blue color channel to a given color temperature.

Still referring to S3060 in FIG. 3, the color consistency model estimation circuit 1206 outputs the generated color consistency models (including the common profiles Comm_Prof_{RG}(x, y) and Comm_Prof_{BG}(x,y) and their associated sets of gammas γ_{j,RG} and γ_{j,BG}) to the color consistency correction circuit 1208.

At S3080, the color consistency correction circuit 1208 stores the received color consistency models in the memory 1208M for use by the color correction circuit 1200 in the correction phase. The estimated common profiles Comm_Prof_{RG}(x,y) and Comm_Prof_{BG}(x,y) in combination with the gammas γ_{j,RG} and γ_{j,BG} for the j-th color temperature constitute a color consistency model for the j-th color temperature. Within the memory 1208M, the color consistency models may be indexed by color temperature (or illumination type) so as to be easily retrieved by the color correction circuit 1200. The stored color consistency models may be referred to herein as reference color consistency models. Similarly, the gammas γ_{j,RG} and γ_{j,BG} may be referred to as reference gammas or reference gamma coefficients.

The color correction circuit 1200 also performs color and/or anti-shading correction of images during a correction phase. In more detail, during the correction phase the color correction circuit 1200 performs anti-shading correction on one or more obtained images using the color consistency models obtained and stored at the memory 1208M during the calibration phase. Example operation of the color correction circuit 1200 in the correction phase will be discussed in more detail below with regard to FIG. 4.

FIG. 4 is a flow chart illustrating an example embodiment of a method for color and/or anti-shading correction. The example embodiment shown in FIG. 4 will be discussed with regard to the imaging system and the color correction circuit 1200 shown in FIG. 1 during a correction phase in which the color correction circuit 1200 performs color and/or anti-shading correction of a captured image of the scene 120. In the correction phase, the scene 120 is not a white (or, more generally, grey) image of uniformity. On the contrary, the scene 120 may be any arbitrary scene. Although the example embodiment shown in FIG. 4 is discussed with regard to a single image of the scene 120, it should be understood that example embodiments are applicable to any number of images of any number of scenes.

Referring to FIG. 4, at S4000 the image sensor 1000 captures an image I_{Orig} of the scene 120 in the same manner as discussed above with regard to S3000 in FIG. 3. The image sensor 1000 outputs the captured image (or image data) I_{Orig} to the white balance correction parameter estimation circuit 1202.

At S3020, the white balance correction parameter estimation circuit 1202 estimates white balance correction parameters for the captured image I_{Orig}. As discussed above, white balance correction parameters include per-color channel gains and an estimated color temperature of the light under which the image I_{Orig} of the scene 120 was captured. Unlike during the calibration phase, the color temperature of light under which the image was captured in the correction phase may not be known, and thus, is estimated by the white balance correction parameter estimation circuit 1202 at S4010. As discussed above with regard to S3010 in FIG. 3, the white balance correction parameter estimation circuit 1202 may estimate the white balance correction parameters in any well-known manner. Moreover, because methods for estimating white balance correction parameters is well-known, a detailed discussion is omitted.

The white balance correction parameter estimation circuit 1202 outputs the estimated white balance correction parameters for the captured image to the white balance correction circuit 1203. The white balance correction parameter estimation circuit 1202 also outputs the estimated white balance correction parameters (e.g., the estimated color temperature for the image) to the color consistency correction circuit 1208.

At S4020, the white balance correction circuit 1203 performs white balance on the captured image I_{Orig} of the scene 120 in the same or substantially the same manner as discussed above with regard to S3020 in FIG. 3. The white balance correction circuit 1203 outputs the white balance corrected image (also referred to as the white balanced image) I_{WB} to the anti-shading correction circuit 1210.

At S4060, the color consistency correction circuit 1208 generates an estimated color consistency model for the captured image based on the estimated color temperature from the white balance correction parameter estimation circuit 1202 and the color consistency models stored in the memory 1208M during the calibration phase.

In more detail, the color consistency correction circuit 1208 calculates a single gamma for each of the red and blue color channels using sets of gammas corresponding to the color temperatures closest to the estimated color temperature from the white balance correction parameter estimation circuit 1202. For example, if the estimated color temperature falls between the j-th and (j+1)th color temperature, then the color consistency correction circuit 1208 generates a single gamma coefficient γ^{R} for the red color channel using simple linear interpolation between the gammas γ_{j,RG} and γ_{j+1,RG}. Similarly, the color consistency correction circuit 1208 generates a single gamma coefficient γ^{B} for the blue color channel using simple linear interpolation between the gammas γ_{j,BG} and γ_{j+1,BG}.

The common profile Comm_Prof_{RG} and the interpolated gamma γ^{R} for the red color channel constitute the estimated color consistency model for the red color channel of the captured image. Similarly, the common profile Comm_Prof_{BG} and the interpolated gamma γ^{B} for the blue color channel constitute the estimated color consistency model for the blue color channel of the captured image.

During the correction phase, the color consistency correction circuit 1208 needs only a single gamma per color channel that is calculated for the estimated color temperature. Thus, the index j used in calculations in the calibration phase is not used in the discussion of the color correction circuit 1200 in the correction phase.

Still referring to FIG. 4, at S4070 the color consistency correction circuit 1208 generates anti-shading correction grids for the captured image using the estimated color consistency models for the red and blue color channels.

In more detail, according to at least one example embodiment, based on the estimated color consistency model for the red color channel, at S4070 the color consistency correction circuit 1208 adapts the anti-shading correction grid G_{αs}^{R} for the red color channel of the captured image according to Equation (7) shown below.

$${G}_{as}^{R} = \frac{{γ}^{R} {p}_{cc}}{{a}^{Gr} {p}_{as}} {Comm\_Prof}_{RG} + {γ}^{R} {p}_{cc} {Comm\_Prof}_{RG} {G}_{as}^{Gr} + {G}_{as}^{Gr} \qquad ( 7 )$$

Similarly, the color consistency correction circuit 1208 adapts the anti-shading shading correction grid G_{αs}^{B} for the blue color channel of the captured image according to Equation (8) shown below.

$${G}_{as}^{B} = \frac{{γ}^{B} {p}_{cc}}{{a}^{Gb} {p}_{as}} {Comm\_Prof}_{BG} + {γ}^{B} {p}_{cc} {Comm\_Prof}_{BG} {G}_{as}^{Gb} + {G}_{as}^{Gb} \qquad ( 8 )$$

As discussed herein, the adapted anti-shading correction grids G_{αs}^{B} and G_{αs}^{R} are also referred to as color shading correction grids.

In Equations (7) and (8), p_{αs} is the power of the anti-shading in the image, p_{cc} is the power of the color shading correction, α^{Gr} is a calibrated coefficient for the green-red color channel, α^{Gb} is a calibrated coefficient for the green-blue color channel, γ^{R} is the interpolated gamma for the red color channel of the captured image, and γ^{B} is the interpolated gamma for the blue color channel of the captured image, G_{αs}^{Gr} is the anti-shading correction grid for the green-red color channel, and G_{αs}^{Gb} is the anti-shading correction grid for the green-blue color channel.

The anti-shading correction grids G_{αs}^{Gr} and G_{αs}^{Gb} are known at the correction stage/phase, having been generated/calibrated during the calibration phase discussed above. However, since calculation of anti-shading correction grids such as anti-shading correction grids G_{αs}^{Gr} and G_{αs}^{Gb} is well-known, a detailed discussion is omitted.

Still referring to Equations (7) and (8), the calibrated coefficient α^{R} for the red color channel is the same as the calibrated coefficient α^{Gr} for the green-red color channel (α^{R}=_{α}^{Gr}), and the calibrated coefficient α^{B} for the blue color channel is the same as the calibrated coefficient α^{Gb} for the green-blue color channel (α^{B}=α^{Gb}).

The color consistency correction power p_{cc} and the anti-shading correction power p_{αs} are user-defined values between 0 and 1 deter mined according to the desired level of correction of the image. The desired correction level, the color consistency correction power p_{cc} and the anti-shading correction power p_{αs} may be determined according to empirical evidence or other information. The alpha coefficients (or alphas) α^{B}, α^{R}, α^{Gr}, α^{Gb} are interpolated from the anti-shading model using well-known methods, which are not described herein for the sake of brevity.

The color consistency correction circuit 1208 outputs the color shading correction grids G_{αs}^{R} and G_{αs}^{B} to the anti-shading correction circuit 1210.

At S4080, the anti-shading correction circuit 1210 corrects for color shading within the white balanced image I_{WB} from the white balance correction circuit 1203 using (or based on) the color shading correction grids G_{αs}^{R} and G_{αs}^{B} from the color consistency correction circuit 1208.

In more detail, the anti-shading correction circuit 1210 generates a color shading correction function G_{cs}^{R} for the red color channel based on the red color shading correction grid G_{αs}^{R} from the color consistency correction circuit 1208 according to Equation (10) shown below.

G_{cs}^{R}=1+p_{αs}α^{R}G_{αs}^{R} (10)

The anti-shading correction circuit 1210 also generates a color shading correction function G_{cs}^{B} for the blue color channel based on the blue color shading correction grid G_{αs}^{B} from the color consistency correction circuit 1208 according to Equation (11) shown below.

G_{cs}^{B}=1+p_{αs}α^{B}G_{αs}^{B} (11)

The color shading correction functions for the red and blue color channels may be expressed more generically as shown below in Equation (12).

G_{cs}ⁱ=1+p_{αs}αⁱG_{αs}ⁱ (12)

In Equation (12), G_{cs}ⁱ is the color shading correction function for the i-th color channel among the red and blue color channels of the image.

Still referring to S4080 in FIG. 4, the anti-shading correction block 1210 then applies the color shading correction function G_{cs}ⁱ to each pixel (x,y) of the white balanced image I_{WB} to correct for color shading in the white balanced image I_{WB}. In more detail, the shading correction block 1210 applies the color shading correction function G_{cs}ⁱ for the i-th color channel (where i is one of R and B) to each pixel value I_{WB}(x,y) to generate a color shading corrected image I_{corr}(x,y) as shown below in Equation (13).

I_{corr}(x,y)=I_{WB}(x,y)·G_{cs}ⁱ, where i ∈ {R, B} (13)

According to at least some example embodiments, the color shading correction functions G_{cs}^{R} and G_{cs}^{B} are generated/adapted using the color correction grids G_{αs}^{R} and G_{αs}^{B}, respectively, and the color shading correction functions G_{cs}^{R} and G_{cs}^{B} are applied to pixels of the white balanced image. As a result, the anti-shading correction circuit 1210 corrects for color shading separately and independently from the lens shading correction of the image. In one example, the anti-shading correction circuit 1210 may correct for only color shading in the white balanced image at S4080.

Returning to FIG. 4, after having performed the color shading correction, at S4090 the anti-shading correction block 1210 corrects for lens shading in the white balanced image I_{WB} by applying an anti-shading gain function gainᵢ to pixels of the color shading corrected image I_{corr}(x,y) as shown below in Equation (14) to generate the anti-shading corrected output image Iₒᵤₜ(x,y).

Iₒᵤₜ(x,y)=I_{corr}(x,y)·gainᵢ (14)

In Equation (14), the lens shading correction function gainᵢ is given by Equation (15) shown below, where i is one of the green-red color channel Gr and the green-blue color channel Gb.

gainᵢ=(1+pₐₛαⁱ·G_{αs}ⁱ) (15)

In Equation (15), the lens shading correction function (also referred to in some cases as an anti-shading gain or anti-shading correction function) is applied for the green-red color channel and the green-blue color channel (i.e., i ∈{Gr, Gb}) of the image to correct for lens shading in the white balanced image I_{WB}.

Still referring to FIG. 4, the color shading correction at S4080 and the lens shading correction at S4090 constitute anti-shading correction of the image of the scene 120.

After having performed the lens shading correction at S4090, the anti-shading correction circuit 1210 outputs the anti-shading corrected output image Iₒᵤₜ(x, y) to the further image processing circuit 1400.

At S4100, the further image processing circuit 1400 performs further image processing (e.g., denoise, demosaic, etc.) on the output image Iₒᵤₜ(x,y) to generate a final output image I_{final}. In one example, the further image processing circuit 1400 may translate the output image Iₒᵤₜ(x,y) from the Bayer domain to a more generic standard (e.g., YUV standard), perform sharpening, filtering, etc. The further image processing unit 1400 may also convert the processed standard image into a desired output format for display and/or storage in a memory, such as the memory. Because each of the functions discussed above with regard to the further image processing circuit 1400 is generally known in the art, a detailed discussion is omitted.

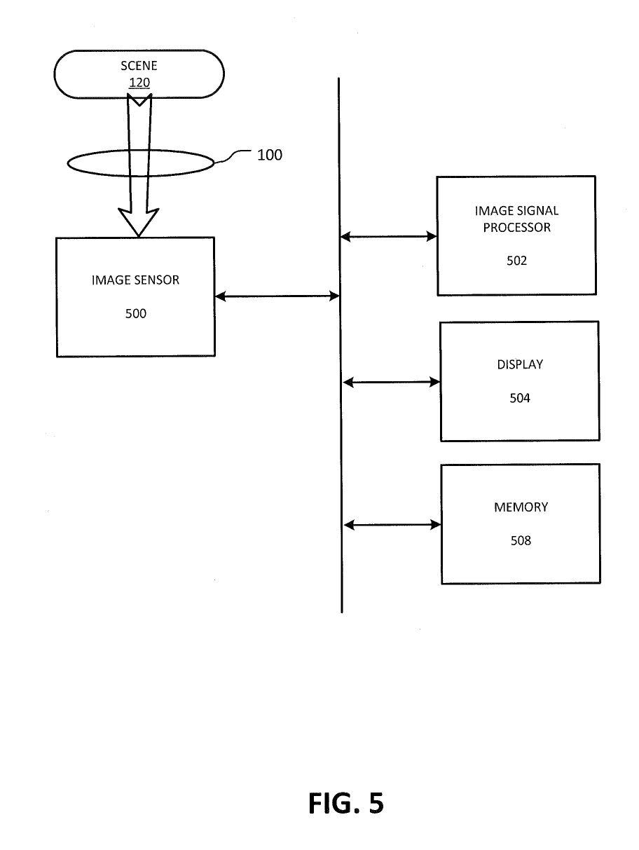

The further image processing circuit 1400 then outputs the final image I_{final} to a display (e.g., display 504 in FIG. 5) for display and/or to a memory (e.g., memory 508 in FIG. 5) for storage.

FIG. 5 is a block diagram illustrating an electronic imaging system according to an example embodiment.

Referring to FIG. 5, the electronic imaging system includes, for example: the lens unit 100 from FIG. 1, an image sensor 500, an image signal processor (ISP) 502, a display 504 and a memory 508. The image sensor 500, the ISP 502, the display 504 and the memory 508 communicate with one another via a bus 506.

The image sensor 500 may be the image sensor 1000 described above with regard to FIGS. 1 and 2. The image sensor 500 is configured to capture image data by converting optical images into electrical signals. The electrical signals are output to the ISP 502.

The ISP 502 processes the captured image data for storage in the memory 508 and/or display by the display 504. In more detail, the ISP 502 is configured to: receive digital image data from the image sensor 500, perform image processing operations on the digital image data, and output a processed image or processed image data. The ISP 502 may include the color correction circuit 1200 and the further image processing circuit 1400 shown in FIG. 1.

The ISP 502 may also be configured to execute a program and control the electronic imaging system. The program code to be executed by the ISP 502 may be stored in the memory 508. The memory 508 may also store the image data acquired by the image sensor and processed by the ISP 502. The memory 508 may be any suitable volatile or non-volatile memory.

The electronic imaging system shown in FIG. 5 may be connected to an external device (e.g., a personal computer or a network) through an input/output device (not shown) and may exchange data with the external device.

The electronic imaging system shown in FIG. 5 may embody various electronic control systems including an image sensor, such as a digital still camera. Moreover, the electronic imaging system may be used in, for example, mobile phones, personal digital assistants (PDAs), laptop computers, netbooks, MP3 players, navigation devices, household appliances, or any other device utilizing an image sensor or similar device.

The foregoing description of example embodiments has been provided for purposes of illustration and description. It is not intended to be exhaustive or limiting. Individual elements or features of a particular example embodiment are generally not limited to that particular example embodiment. Rather, where applicable, individual elements or features are interchangeable and may be used in a selected embodiment, even if not specifically shown or described. The same may also be varied in many ways. All such modifications are intended to be included within the scope of this disclosure.

1. An imaging system comprising:
a color correction circuit configured to perform color shading correction of an image independent of lens shading correction of the image, the color shading correction of the image being based on estimated color consistency models for red and blue color channels of the image; wherein
the estimated color consistency model for the red color channel includes a common profile for the red color channel and a scaling factor for the red color channel,
the estimated color consistency model for the blue color channel includes a common profile for the blue color channel and a scaling factor for the blue color channel, and
the scaling factors for the red and blue color channels correspond to an estimated color temperature for the image.

2. The imaging system of claim 1, wherein the color correction circuit comprises:
a color consistency correction circuit configured to generate color shading correction grids by adapting anti-shading correction grids for the red and blue color channels of the image based on the estimated color consistency models for the red and blue color channels of the image; and
an anti-shading correction circuit configured to perform the color shading correction of the image based on the color shading correction grids.

3. The imaging system of claim 2, wherein the color consistency correction circuit is configured to generate the color shading correction grids by adapting anti-shading correction grids for only the red and blue color channels.

4. An imaging system comprising:
a color correction circuit configured to perform color shading correction of an image independent of lens shading correction of the image, the color correction circuit including
a color consistency correction circuit configured to generate color shading correction grids by adapting anti-shading correction grids for red and blue color channels of the image based on estimated color consistency models for the red and blue color channels of the image, and
an anti-shading correction circuit configured to perform the color shading correction of the image based on the color shading correction grids; wherein
the estimated color consistency model for the red color channel includes a common profile for the red color channel and an estimated gamma coefficient for the red color channel,
the estimated color consistency model for the blue color channel includes a common profile for the blue color channel and an estimated gamma coefficient for the blue color channel, and
the estimated gamma coefficients for the red and blue color channels correspond to an estimated color temperature for the image.

5. The color correction circuit of claim 4, wherein the color consistency correction circuit is configured to generate the estimated gamma coefficient for the red color channel based on a plurality of reference gamma coefficients for the red color channel using interpolation, the plurality of reference gamma coefficients for the red color channel corresponding to a plurality of reference color temperatures.

6. The color correction circuit of claim 4, wherein the color consistency correction circuit is configured to generate the estimated gamma coefficient for the blue color channel based on a plurality of reference gamma coefficients for the blue color channel using interpolation, the plurality of reference gamma coefficients for the blue color channel corresponding to a plurality of reference color temperatures.

7. The imaging system of claim 2, wherein the anti-shading correction circuit is further configured to,
generate color shading correction functions for each of the red and blue color channels based on the color shading correction grids, and
perform the color shading correction of the image by applying the color shading correction functions to each pixel of the image.

8. The imaging system of claim 2, wherein the anti-shading correction circuit is further configured to perform the lens shading correction of the image.

9. The imaging system of claim 2, wherein the color consistency correction circuit is further configured to generate the estimated color consistency models for the red and blue color channels of the image based on the estimated color temperature for the image.

10. The imaging system of claim 9, wherein the color consistency correction circuit is further configured to,
obtain reference color consistency models for the red and blue color channels based on the estimated color temperature for the image, and
generate the estimated color consistency models for the red and blue color channels based on the obtained reference color consistency models for the red and blue color channels.

11. An imaging system comprising:
a color correction circuit configured to perform color shading correction of an image independent of lens shading correction of the image, the color correction circuit including
a color consistency correction circuit configured to generate color shading correction grids by adapting anti-shading correction grids for red and blue color channels of the image based on estimated color consistency models for the red and blue color channels of the image,
an anti-shading correction circuit configured to perform the color shading correction of the image based on the color shading correction grids,
a color inconsistency information extraction circuit configured to extract color inconsistency information from a plurality of reference images, each of the plurality of reference images being captured under light having a different color temperature among a plurality of reference color temperatures, and
a color consistency model estimation circuit configured to generate a reference color consistency model for each of the plurality of reference images, the color consistency model estimation circuit being further configured to store the reference color consistency models in a memory;
wherein the color consistency correction circuit is further configured to
obtain reference color consistency models for the red and blue color channels based on an estimated color temperature for the image, and
generate the estimated color consistency models for the red and blue color channels based on at least a portion of the reference color consistency models and the estimated color temperature for the image.

12. The imaging system of claim 11, wherein extracted color inconsistency information for a reference image among the plurality of reference images includes a ratio of green-to-red color channels for each pixel of the reference image and a ratio of green-to-blue color channels for each pixel of the reference image.

13. The imaging system of claim 11, wherein a reference color consistency model for a reference image among the plurality of reference images includes a common profile and a reference gamma coefficient corresponding to a color temperature for the reference image, and wherein the color consistency model estimation circuit is configured to,
calculate the common profile based on an initial reference gamma coefficient,
calculate an updated reference gamma coefficient based on the calculated common profile,
calculate an updated common profile based on the updated reference gamma coefficient, and
iteratively repeat the calculation of the updated reference gamma coefficient and the updated common profile until convergence to generate the reference color consistency model for the reference image.

14. The imaging system of claim 1, further comprising:
an image sensor operatively coupled to the color correction circuit, the image sensor being configured to capture the image.

15.-25. (canceled)
